(19) United States
(12) Patent Application Publication
(10) Pub. No.: US 2025/0085997 A1
(43) Pub. Date: Mar. 13, 2025

(54) MULTI-OS HETEROGENEOUS VIRTUAL MACHINE

(71) Applicant: Hewlett Packard Enterprise Development LP, Spring, TX (US)

(72) Inventors: Kenneth Eugene James, Windsor, CO (US); James R. Hamrick, JR., Murrieta, CA (US)

(21) Appl. No.: 18/466,800

(22) Filed: Sep. 13, 2023

(51) Int. Cl. G06F 9/455

(52) U.S. Cl. CPC G06F 9/45558; G06F 2009/45583; G06F 2009/45595

(57) ABSTRACT

A system for running a virtual machine (VM) on a host device is provided. During operation, the system can execute, within the VM, a first operating system (OS) running a client application and a second OS running a network protocol stack. The first OS can receive a transaction command from the client application. The transaction command can be associated with a remote memory access. The first OS can then convert the transaction command to one or more network packets and provide a description of the one or more network packets to the second OS via a shared guest physical memory of the VM. The host device can then send the one or more network packets to a corresponding destination based on the network protocol stack.

### BACKGROUND

A virtual machine (VM) in a VM cloud may support different operating systems (OSs) and services. For example, the VM can support a specialized OS that can facilitate specialized applications facilitating critical services, such as real-time operations in banking, finance, flight management, etc. The VM can then require fault tolerance and scalability to efficiently support large quantities of transactions.

### BRIEF DESCRIPTION OF THE FIGURES

FIG. 1A illustrates an example of a heterogeneous VM (HVM) running multiple OS instances, in accordance with an aspect of the present application.

FIG. 1B illustrates an example of communication between multiple OS instances running on an HVM, in accordance with an aspect of the present application.

FIG. 1C illustrates an example of communication between an HVM and an auxiliary VM (AVM), in accordance with an aspect of the present application.

FIG. 2 presents a flowchart illustrating an example of the process of an HVM booting up a service OS (SOS) and an ancillary OS (AOS) on the HVM, in accordance with an aspect of the present application.

FIG. 3A presents a flowchart illustrating an example of the process of an SOS generating a packet based on a remote memory access transaction, in accordance with an aspect of the present application.

FIG. 3B presents a flowchart illustrating an example of the process of an AOS obtaining and transmitting a packet generated by an SOS, in accordance with an aspect of the present application.

FIG. 4 illustrates an example of a computing system facilitating an HVM, in accordance with an aspect of the present application.

FIG. 5 illustrates an example of an apparatus that facilitates an HVM, in accordance with an aspect of the present application.

In the figures, like reference numerals refer to the same figure elements.

### DETAILED DESCRIPTION

Specialized applications facilitating critical services, such as real-time banking, stock trading, and flight management, require high availability and scalability. Therefore, these applications may run on systems that can facilitate such features. Such a system can include a set of computation units (e.g., a cloud-based computation cluster). A respective computation unit can include a plurality of processor cores and a memory device. The computation unit can include a network interface controller (NIC) to facilitate external communication. Each computation unit can run an SOS, such as NonStop OS (NSOS), that can support the specialized application. The SOS can be deployed as a guest OS on a service VM (SVM) running on the system. The SVM running on the system can facilitate a high-availability service environment (e.g., in a virtual NonStop (vNS) environment).

The environment may include a plurality of SVMs, each running an instance of the SOS. The environment may also require additional auxiliary VMs (AVMs) to facilitate services and operations that are not supported by the SOS. An orchestrator can be used to configure and provision the SVMs and AVMs. AVMs can facilitate storage and networking operations for the SVMs. Typically, the SVMs of the environment communicate with the AVMs using remote memory access, such as Remote Direct Memory Access (RDMA), via switching fabrics. As a result, the host device of an SVM may require RDMA-supporting NIC (R-NIC). An R-NIC can be a specialized NIC that can support RDMA-based operations. Due to the dependence on remote memory access (RMA) for external communication, deploying SOS on VMs running on a public cloud can be challenging.

The aspects described herein address the problem of efficiently deploying SOS on VMs running on a public cloud by (i) instantiating, on a heterogeneous VM (HVM), the SOS with an ancillary OS (AOS) capable of supporting external communication using a network protocol stack; (ii) deploying, in the SOS, a virtual NIC that can convert RMA transactions to network packets, and (iii) providing the packets to the AOS using a shared guest memory space of the HVM. Because the AOS can facilitate external communication based on the network protocol stack, the underlying host device of the HVM can use a standard NIC (e.g., an Ethernet NIC) to forward packets received from the HVM. As a result, by running on the HVM, the SOS can be deployed on the standard host devices of a public cloud.

With existing technologies, because SOS can be a specialized OS, the operations supported by the SOS can be limited to the ones required for running specialized applications. As a result, the SOS may not support some features, such as storage or networking, typically available in a standard OS, such as Linux or Unix. Furthermore, to facilitate high availability, operations executing on the SOS may be synchronized with another instance of the SOS (e.g., between process pairs). Consequently, the SOS may rely on remote memory access, such as RDMA, for external communications. As a result, if the SOS is deployed on a VM, the host device running the VM may require a host device with specialized hardware for facilitating the remote memory access. For example, the host device may require R-NIC, which can facilitate RDMA-based operations issued by the VM.

Since the SOS can ensure high availability and scalability, running the SOS may be necessary for a VM executing critical specialized applications. Examples of the specialized applications can include, but are not limited to, real-time banking operations, stock trading, and flight management. To supplement the missing features of the SOS, an additional OS on a separate AVM can be used. For example, in a vNS environment, a VM running SOS can use a Cluster I/O Module (CLIM) to supplement the missing features. The SOS can communicate with the CLIM via RMA. Here, RMA can facilitate data transfer from a device to the memory of a remote processor without involving the processor of the device. The R-NIC is generally required on both the host devices running the VM and the CLIM. Such requirements can significantly limit the deployment of the SOS. In particular, such an environment may not be deployable on the computer systems of a public cloud.

To address this problem, the SOS can be deployed on a heterogeneous VM (HVM) that can also run another AOS that can facilitate external communication for the HVM. Therefore, a single HVM can run two OS instances—a primary OS, which can be the SOS, and a secondary OS, which can be the AOS. The AOS can be a standard OS (e.g., Linux or Unix) that can incorporate a network protocol stack using which the HVM can support external communication. The AOS can include a NIC driver using which the AOS can communicate and manage the standard NIC (e.g., an Ethernet NIC) of the underlying host device of the HVM. The guest physical memory of the HVM, which is the virtual memory presented as the physical memory to the HVM, can be split into three partitions. Two of these partitions can be allocated to the SOS and the AOS, respectively. The third partition can be configured as a piece of shared memory accessible by the SOS and the AOS.

The virtual (or logical) processor cores of the HVM can be distributed among the SOS and the AOS. Here, a respective virtual processor core can operate a virtual processing unit. Since the SOS can run specialized applications, more cores can be allocated to the SOS. Accordingly, the SOS can run specialized applications using the allocated processor cores on the memory partition allocated to the SOS. To ensure high availability, the data generated or updated by a process of the application can be synchronized with a remote process of a process pair running on another SOS instance. As a result, the application can issue commands (or instructions) based on RMA (e.g., RDMA). Such a command can lead to a corresponding RMA transaction (e.g., a read or write operation on a remote memory location). The remote process can be the target process for the transaction. A virtual R-NIC (VR-NIC) can be integrated with the SOS that can receive the RMA transactions from the application running on the SOS. As a result, the applications running on the SOS can continue to operate without modification.

The VR-NIC can emulate RMA such that the application can provide the RMA transactions without perceiving the VR-NIC as a virtual apparatus. The VR-NIC can translate a respective RMA transaction into a regular network packet, such as an Ethernet frame, and provide the packet to the network protocol stack of the AOS via the shared memory. The VR-NIC can place a description of the packet in a queue in the shared memory and issue an inter-processor interrupt (IPI) to the AOS. The description can indicate the memory location of the packet. The IPI can prompt the AOS to obtain, via a processor core allocated to the AOS, the packet based on the description in the queue. The network protocol stack of the SOS can process the packet. Subsequently, the stack can provide the packet to the NIC of the host device via the NIC driver.

The NIC may place the packet in an egress queue (or output buffer) associated with the destination of the packet. The NIC can then transmit the packet from the egress queue over a network. Because the HVM uses the AOS to interact with the host device, the HVM can be deployed on a standard host device (e.g., on the host device or on a hypervisor executing on the host device). By running on the HVM, the SOS can be deployed on a host device of a public cloud without requiring the host device to be equipped with an R-NIC.

In this disclosure, the term “switch” is used in a generic sense, and it can refer to any standalone or fabric switch operating in any network layer. “Switch” should not be interpreted as limiting examples of the present invention to layer-2 networks. Any device that can forward traffic to an external device or another switch can be referred to as a “switch.” Any physical or virtual device (e.g., a virtual machine or switch operating on a computing device) that can forward traffic to an end device can be referred to as a “switch.” Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

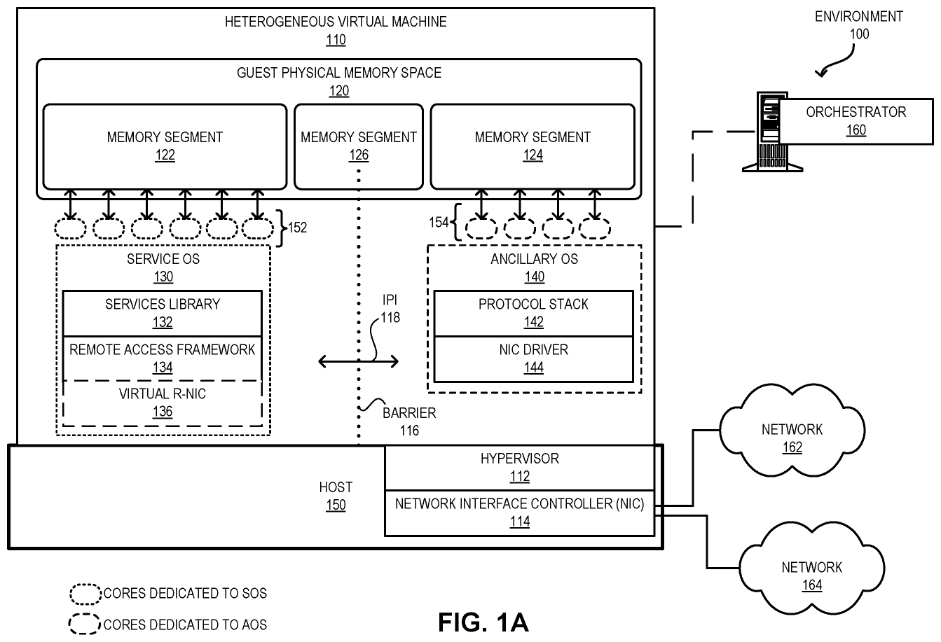

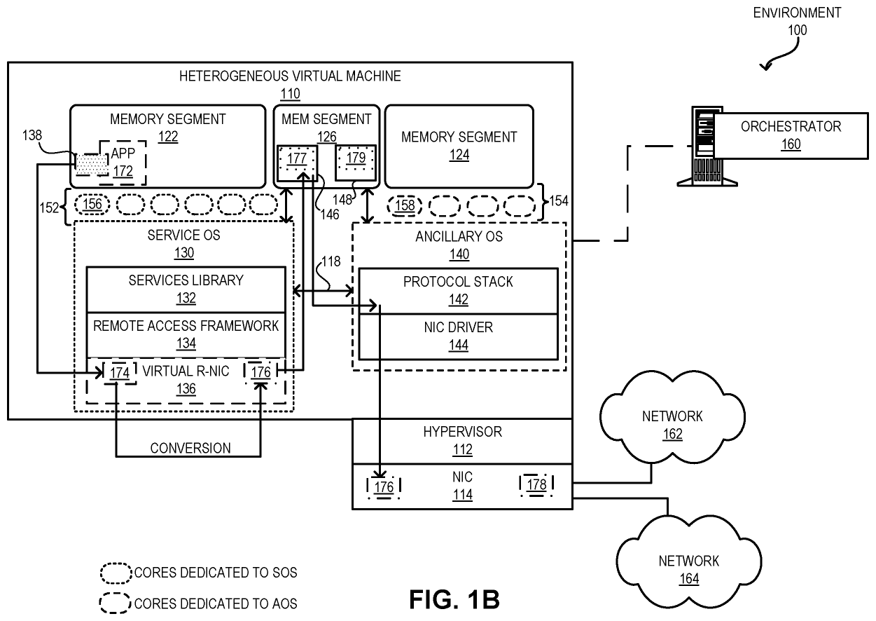

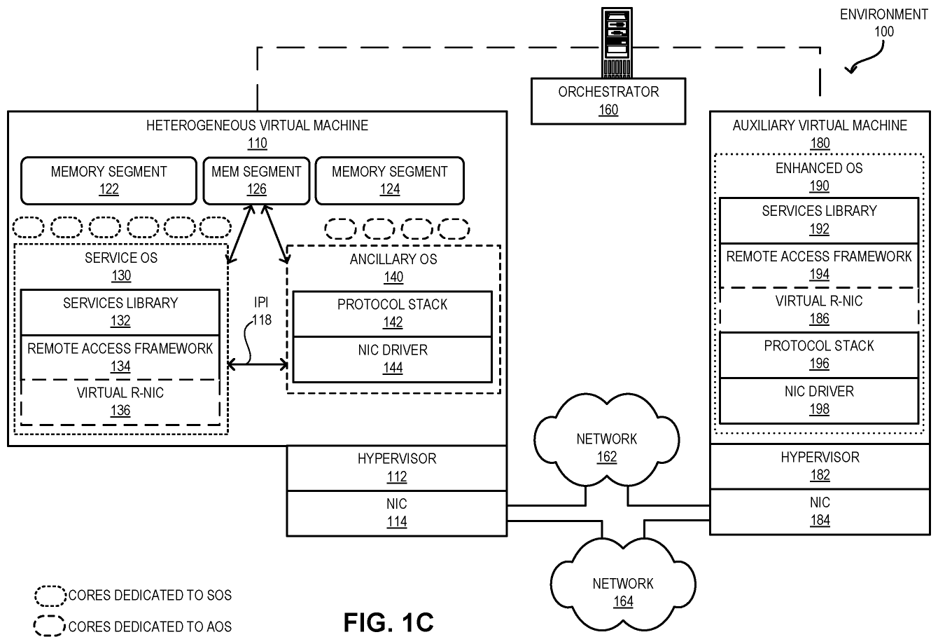

FIG. 1 illustrates an example of an HVM running multiple OS instances, in accordance with an aspect of the present application. A high-availability service environment 100 (e.g., a vNS environment) can include one or more VMs, each capable of running an instance of SOS 130. With existing technologies, environment 100 can also include AVMs to facilitate services and operations that are not supported by SOS 130. An orchestrator 160 can be used to configure and provision the VMs and devices in environment 100. Orchestrator 160 can run on a computing system accessible via the cloud. Typically, the VMs running SOS 130 can communicate with the AVMs using RMA (e.g., RDMA) via one or more networks, such as networks 162 and 164. Examples of networks 162 and 164 can include, but are not limited to, fabric-switching network, Ethernet network, and Internet Protocol (IP) network. Networks 162 and 164 may facilitate redundancy to each other within environment 100.

Because SOS 130 can be a specialized OS, the operations supported by SOS 130 can be limited to the ones required for running specialized applications. As a result, SOS 130 may not support some features, such as storage or networking, typically available in a standard OS, such as Linux or Unix. Furthermore, to facilitate high availability, SOS 130 may rely on RMA (e.g., RDMA) for external communications. As a result, if SOS 130 is deployed on a VM, the host device running the VM may require a host device with specialized hardware, such as an R-NIC, for facilitating RMA. The R-NIC is generally required on the host devices running the VM and the AVMs. Such requirements can significantly limit the deployment of SOS 130. In particular, such a system may not be deployable on the computer systems of a public cloud.

To address this problem, SOS 130 can be deployed on an HVM 110 that can also run another AOS 140 that can facilitate external communication for HVM 110. HVM 110 can run on a host device 150 or a hypervisor 112 running on host device 150. Hypervisor 112 can be a virtual machine manager (VMM) that can support a VM running SOS 130 and present a guest physical memory 120 to HVM 110. Hypervisor 112 can be the native hypervisor running on host device 150. Examples of hypervisor 112 can include, but are not limited to, VMware hypervisor (e.g., vSphere, Elastic Sky X (ESX), ESX integrated (ESXi), Microsoft Hyper-V, and Oracle VM Server). Host device 150 can be equipped with a general-purpose NIC 114 (e.g., an Ethernet NIC).

On host device 150, the same HVM 110 can run two OS instances—a primary OS, which can be SOS 130, and a secondary OS, which can be AOS 140. AOS 140 can be a standard operating system (e.g., Ubuntu Linux or FreeBSD Unix) that can incorporate a network protocol stack using which HVM 110 can support external communication. AOS 140 can include a NIC driver 144 using which AOS 140 can communicate and manage NIC 114 of host device 150. Guest physical memory 120 presented to HVM 110 can be partitioned into three memory segments 122, 124, and 126. Guest physical memory 120 can be the virtual memory presented as the physical memory to HVM 110. Memory segments 122 and 124 can be allocated to SOS 130 and AOS 140, respectively. Memory segment 126 can be configured as a piece of shared memory accessible by SOS 130 and AOS 140.

The virtual (or logical) processor cores of HVM 110 can be distributed among SOS 130 and AOS 140. For example, virtual processor cores 152 and virtual processor cores 154 of HVM 110 can be allocated to SOS 130 and AOS 140, respectively. Processor cores 152 and 154 may or may not be non-overlapping (i.e., the same virtual processor core may or may not be allocated to more than one OS). Here, a respective virtual processor core can operate a virtual processing unit. SOS 130 can run specialized applications, SOS 130 may require more processing resources. Hence, the number of cores of processor cores 152 can be larger than that of processor cores 154. Scheduling of processor cores 152 and 154 on the physical processor cores of host device 150 can be performed by hypervisor 112. Accordingly, SOS 130 can run specialized applications using processor cores 152 on memory segment 122. On the other hand, AOS 140 can run on memory segment 124 using processor cores 154. The non-overlapping assignment of processor cores and memory to SOS 130 and AOS 140 can create a barrier 116 between the two OS instances. Barrier 116 indicates the separation of running space (i.e., the separate memory and processor cores) for SOS 130 and AOS 140.

SOS 130 can include a services library 132 and a remote access framework 134. Library 132 can facilitate access to the resources (e.g., different daemons of SOS 130) to the applications running on SOS 130 based on a set of functions supported by library 132. Furthermore, remote access framework 134 can facilitate RMA to the applications. Framework 134 can support a set of RMA technologies for external communication. Examples of the RMA technologies can include, but are not limited to, InfiniBand, RDMA over Converged Ethernet (RoCE), and Internet Wide-area RDMA Protocol (iWARP). Library 132 and framework 134 can operate in conjunction with each other to allow the applications running on SOS 130 to communicate with an external entity using RMA. If SOS 130 is NSOS, library 132 can include a NonStop Connection Services Library (NCSL), and framework 134 can include OpenFabrics Enterprise Distribution (OFED) framework.

A VR-NIC 136 can be implemented in SOS 130, which can include a virtualized R-NIC (e.g., a virtual RoCE NIC). VR-NIC 136 can receive the RMA transactions from the application running on SOS 130. VR-NIC 136 can then translate a respective RMA transaction into a regular network packet, such as an Ethernet frame, and provide the packet to network protocol stack 142 of AOS 140 via memory segment 126. Examples of stack 142 can include, but are not limited to, the Internet Protocol stack and Open Systems Interconnection (OSI) protocol stack. Stack 142 can include a suite of network protocols facilitating communication based on Transmission Control Protocol (TCP)/IP.

VR-NIC 136 can also issue an IPI 118 to AOS 140. Based on IPI 118, AOS 140 can be prompted to obtain the packet and process it using stack 142. Subsequently, stack 142 can provide the packet to NIC 114 via NIC driver 144. NIC 114 may place the packet in an egress queue associated with the destination of the packet. NIC 144 can then transmit the packet from the egress queue over network 162 or 164. Because HVM 110 uses AOS 140 to interact with host device 150, HVM 110 can be deployed on a standard computing system (e.g., on host device 150 or on hypervisor 112). By running on HVM 110, SOS 130 can be deployed on host device 150, which is equipped with a standard NIC 114. Therefore, to run SOS 130, host device 150 does not need to be equipped with an R-NIC.

The architecture of HVM 110 can be transparent to the software layers above VR-NIC 136. Such layers can include library 132 and framework 134. As a result, library 132 and framework 134 can be compatible with the executable code or “binary” of the applications running on SOS 130. For example, if a server is deployed on SOS 130, the code of the server does not need to be modified to run on HVM 110. In addition, AOS 140 can facilitate the interactions with hypervisor 112. Since AOS 140 can be a standard OS, such as FreeBSD, AOS 140 can be supported as a guest OS on many hypervisors. Consequently, executing HVM 110 on hypervisor 112 can avoid interdependencies between SOS 130 and hypervisor 112. Since processor cores 154 can execute the operations associated with external communication (e.g., cloud access), processor cores 152 can be dedicated to the operations of SOS 130. Consequently, VR-NIC 136 can operate with high efficiency.

HVM 110 can include a boot loader that can boot SOS 130 and AOS 140 (i.e., bring the two OSes up). The boot loader can boot AOS 140 first followed by SOS 130. HVM 110 can also facilitate coordinated error handling and recovery logic to respond to issues encountered by SOS 130 and AOS 140. HVM 110 can also incorporate tools to collect and analyze a consolidated “core dump,” which can be a file generated in response to a program crash. Under such a scenario, the core dump can include states from both SOS 130 and AOS 140. HVM 110 may provide the core dump to orchestrator 160 for further analysis. HVM 110 can also support event logging and performance monitoring for SOS 130 and AOS 140. Accordingly, HVM 110 can generate an entry in a log file indicating a respective event incurred by SOS 130 and AOS 140. Orchestrator 160 can supply key-value pair initialization parameters to HVM 110, thereby allowing it to communicate with other HVMs running on different hypervisors.

FIG. 1B illustrates an example of communication between multiple OS instances running on an HVM, in accordance with an aspect of the present application. During operation, SOS 130 can run an application 172 using one or more of processor cores 152, such as processor core 156, on memory segment 122. Similarly, AOS 140 can run on memory segment 124 using one or more of processor cores 154, such as processor core 158. To ensure high availability, the data generated or updated by a process of application 172 can be synchronized with a remote process of a process pair running on another SOS instance. From application 172's perspective, VR-NIC 136 can be an R-NIC. Application 172 can issue an RMA transaction 174 associated with RMA to VR-NIC 136 to facilitate synchronization with the remote process. Transaction 174 can include data needed to transfer based on transaction 174 (i.e., data updated or generated in association with transaction 174). Transaction 174 can also include a request or trigger for VR-NIC 136.

Accordingly, VR-NIC 136 can obtain transaction 174 from a predetermined memory location 138 in memory segment 122 allocated to application 172. VR-NIC 136 can obtain transaction 174 from memory segment 122 via processor core 156 by emulating RMA (e.g., based on RDMA). VR-NIC 136 can then translate transaction 174 to a packet 176 (e.g., an Ethernet frame). To do so, VR-NIC 136 can determine the address information of the target process of transaction 174. The address information can include a media access control (MAC) and/or IP address associated with the host device on which the target process is being executed. The header of packet 176 can then include the address information. The payload of packet 176 can include the data that needs to be transferred in association with transaction 174. Packet 176 may also indicate the location where the data needs to be placed.

VR-NIC 136 can then place a reference 177 to packet 176 (e.g., a description 177 of packet 176) in a queue 146 in shared memory segment 126. Description 177 can indicate the memory location of packet 176. Queue 146 can be a consumer-producer queue where VR-NIC 136 can produce, and AOS 140 can consume. In other words, VR-NIC 136 can place (or enqueue) items in queue 146, and AOS 140 can retrieve (or dequeue) the item from queue 146. Queue 146 can be an event queue. When packet 176 is placed in queue 146, AOS 140 can receive a trigger and determine that packet 176 should be retrieved. The trigger can be IPI 118 issued to one of processor cores 154, such as processor core 158. AOS 140 can then obtain, via processor core 158, packet 176 based on description 177 in queue 146. Stack 142 can then process packet 176 and provide packet 176 to NIC 114. NIC driver 144 can facilitate an interface to stack 142 that can be used to provide packet 176 to NIC 114. NIC 114 can place packet 176 in an egress queue of NIC 114. Subsequently, NIC 114 can transmit packet 176 over network 162 or 164 based on the address information of the packet. In this way, application 172 can continue to operate on SOS 130 without requiring a modification.

In the same way, when NIC 114 receives a packet 178 from network 162 or 164, NIC 114 can provide the packet to stack 142 via NIC driver 144. If the packet is destined for application 172, AOS 140 can place a description 179 of packet 178 in a queue 148 in shared memory segment 126. Queue 148 can also be a consumer-producer queue where AOS 140 can produce, and VR-NIC 136 can consume. Therefore, AOS 140 can be allowed to enqueue into queue 148, and VR-NIC 136 can be allowed to dequeue from queue 148. An IPI can then be issued to one of processor cores 152, such as processor core 156. Accordingly, VR-NIC 136 can obtain, via processor core 156, packet 178 based on description 179 in queue 148. VR-NIC 136 can process packet 178 and provide packet 178 to application 172.

Because shared memory segment 126 is part of the guest physical memory accessible by SOS 130 and AOS 140, communication between SOS 130 and AOS 140 can be efficient. Moreover, the architecture of HVM 110 can maintain the fault-tolerance and security level SOS 130. In particular, potential vulnerabilities and exposures associated with AOS 140 can be mitigated by running AOS 140 for the purpose of providing external communications (e.g., offloading cloud access services). Therefore, the purpose of running AOS 140 in HVM 110 can be limited to facilitating services missing in SOS 130. Accordingly, AOS 140 may not be externally accessible by a user. Consequently, AOS 140 and its resources, such as memory segment 124 and processor cores 154, may not be available to scripts and applications, such as application 172, running on SOS 130.

FIG. 1C illustrates an example of communication between an HVM and an AVM, in accordance with an aspect of the present application. Environment 100 may also include an AVM 180 (e.g., a CLIM VM) to support additional services, such as storage. AVM 180 can run on a hypervisor 182. Typically, AVM 180 may deploy an enhanced OS (EOS) 190, which can be an enhanced version of a standard OS, such as Linux. The enhancement to the standard OS can include the incorporation of a services library 192 and remote access framework 194 into EOS 190. Framework 194 can support a set of RMA technologies for external communication. Library 132 and framework 134 can operate in conjunction with each other to allow the applications running on EOS 190 to communicate with an external entity using RMA. If EOS 190 is enhanced to support NSOS, library 192 can include NCSL, and framework 194 can include OFED framework.

AVM 180 does not need an additional OS because EOS 190 can include a network protocol stack 196. AVM 180 can perform external communication based on stack 196. The host device of AVM 180 can be equipped with a general-purpose NIC 184 (e.g., an Ethernet NIC). EOS 190 can include a NIC driver 198 using which AVM 180 can communicate and manage NIC 184 of the host device. A VR-NIC 186 can be implemented in EOS 190, which can include a virtualized R-NIC (e.g., a virtual RoCE NIC). During operation, a process or application running on EOS 190 can issue an RMA transaction to communicate with HVM 110.

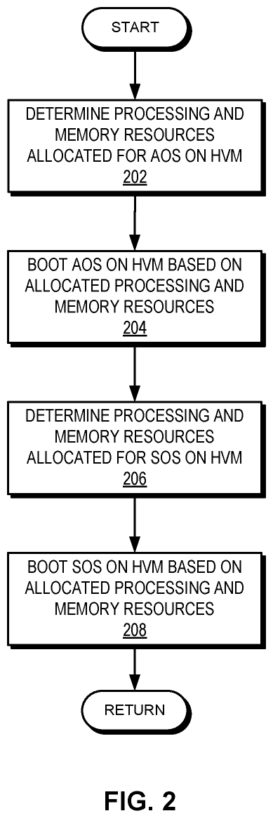

VR-NIC 186 can receive the RMA transaction and translate the RMA transaction into a regular network packet, such as an Ethernet frame. As a result, even if the communication between AVM 180 and HVM 110 is based on a standard network protocol, such as Ethernet, the services supported by AVM 180 can continue to operate based on RMA without modifications. VR-NIC 186 can then provide the packet to stack 196 for processing. Subsequently, stack 196 can provide the packet to NIC 184 via NIC driver 198. NIC 184 can then transmit the packet over network 162 or 164 to HVM 110. Upon receiving the packet at NIC 114, VR-NIC 136 can convert the packet to a corresponding RMA transaction, as described in conjunction with FIG. 2.

FIG. 2 presents a flowchart illustrating an example of the process of an HVM booting up an SOS and an AOS on the HVM, in accordance with an aspect of the present application. The HVM can deploy a boot loader for the booting up process. During operation, the HVM can determine the processor and memory resources allocated for the AOS on the HVM (operation 202). The processors and memory allocated to the AOS and SOS can be predetermined, as described in conjunction with FIG. 1. The HVM can then boot the AOS on the HVM based on the allocated processing and memory resources (operation 204). Subsequently, the HVM can determine the process and memory resources allocated for the SOS on the HVM (operation 206) and boot the SOS on the HVM based on the allocated processing and memory resources (operation 208). In this way, the SOS and the AOS can boot up and run within the HVM.

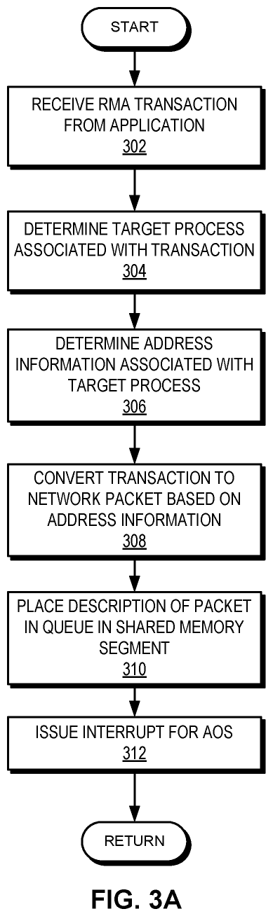

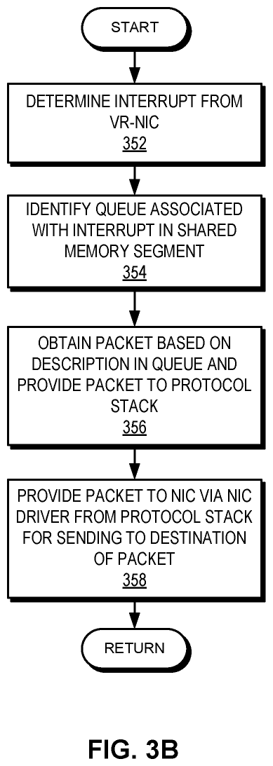

FIG. 3A presents a flowchart illustrating an example of the process of a SOS generating a packet based on a remote memory access transaction, in accordance with an aspect of the present application. The VR-NIC of the SOS can perform the process. During operation, the VR-NIC can receive an RMA transaction from an application (operation 302) and determine a target process associated with the transaction (operation 304). The VR-NIC can determine the address information associated with the target process (operation 306) and convert the transaction into a network packet (e.g., an Ethernet frame) based on the address information (operation 308). The VR-NIC can then place a description of the packet in a queue in the shared memory segment (operation 310) and issue an interrupt for the AOS (operation 312). Using the queue and the interrupt, the SOS can provide the packet to the AOS.

FIG. 3B presents a flowchart illustrating an example of the process of an AOS obtaining and transmitting a packet generated by an SOS, in accordance with an aspect of the present application. During operation, the AOS can determine an interrupt from the VR-NIC (operation 352) and identify a queue associated with the interrupt in the shared memory segment (operation 354). The AOS can then obtain the packet based on the description in the queue and provide the packet to the local protocol stack (operation 356). The AOS can then provide the packet to the NIC via the NIC driver (e.g., using an interface presented by the NIC driver) from the protocol stack for sending the packet to the destination of the packet (operation 358). Subsequently, the NIC can transmit the packet based on the address information of the packet.

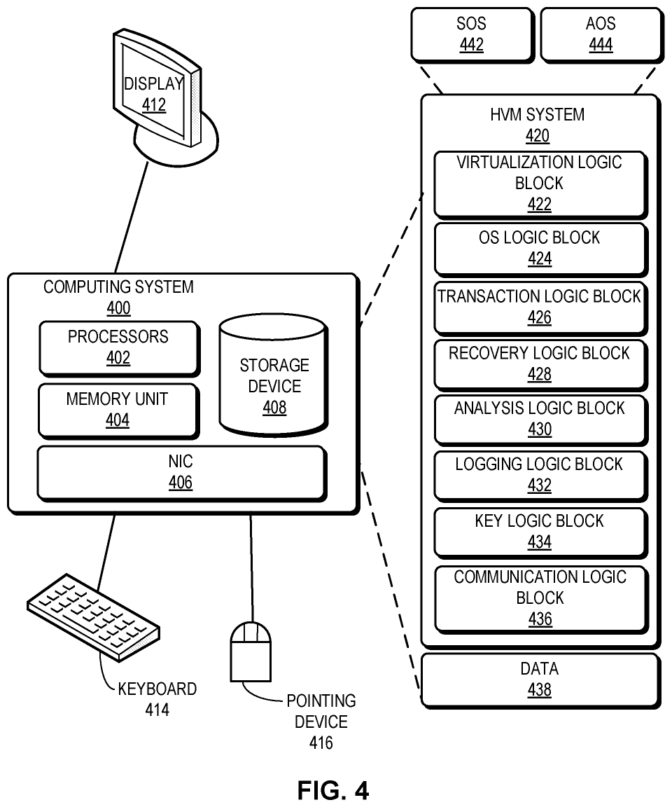

FIG. 4 illustrates an example of a computing system facilitating an HVM, in accordance with an aspect of the present application. A computing system 400 can include a set of processors 402, a memory unit 404, a NIC 406, and a storage device 408. Memory unit 404 can include a set of volatile memory devices (e.g., dual in-line memory module (DIMM)). Furthermore, computing system 400 may be coupled to a display device 412, a keyboard 414, and a pointing device 416, if needed. Computer system 400 can execute an HVM system 420. Storage device 408 can store data 438 associated with HVM system 420. HVM system 420 can operate as a VM on computing system 400.

HVM system 420 can include instructions, which when executed by computing system 400, can cause computing system 400 to perform methods and/or processes described in this disclosure. Specifically, HVM system 420 can include instructions for running a VM (virtualization logic block 422). HVM system 420 can include instructions for booting up and executing an AOS 444 (OS logic block 424). HVM system 420 can also include instructions for booting up and executing an SOS 442 (OS logic block 424). In addition, HVM system 420 can include instructions for converting a transaction to one or more network packets (transaction logic block 426). HVM system 420 can further include instructions for facilitating coordinated error handling and recovery logic to respond to issues encountered by SOS 442 and AOS 444 (recovery logic block 428). Moreover, HVM system 420 can include instructions for collecting and analyzing a consolidated “core dump” from SOS 442 and AOS 444 (analysis logic block 430).

HVM system 420 can include instructions for providing the core dump to an orchestrator for further analysis (analysis logic block 430). Furthermore, HVM system 420 can include instructions for event logging and performance monitoring for SOS 442 and AOS 444 (logging logic block 432). HVM system 420 can include instructions for obtaining and maintaining key-value pair initialization parameters for communicating with other HVM systems (key logic block 434). HVM system 420 may include further instructions for sending and receiving packets based on respective destinations (communication logic block 436). Data 438 can include any data that can facilitate the operations of HVM system 420. Data 438 can include, but is not limited to, an image of SOS 442, an instance of AOS 444, and data stored in event queues.

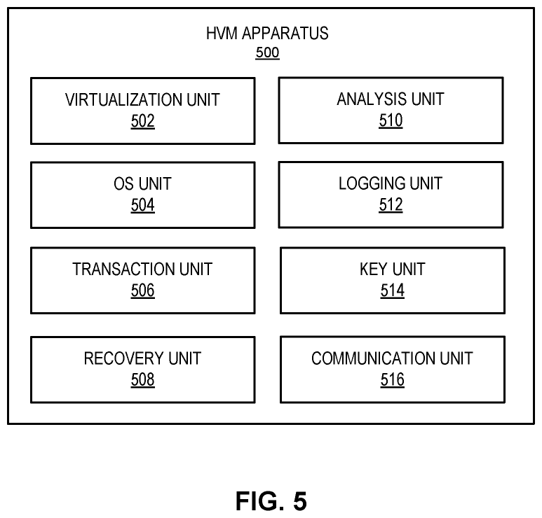

FIG. 5 illustrates an example of an apparatus that facilitates an HVM, in accordance with an aspect of the present application. HVM apparatus 500 can comprise a plurality of units or apparatuses which may communicate with one another via a wired, wireless, quantum light, or electrical communication channel. Apparatus 700 may be realized using one or more integrated circuits, and may include fewer or more units or apparatuses than those shown in FIG. 5. Further, apparatus 500 may be integrated with a computer system, or realized as a specialized device. For example, apparatus 500 can be an accelerator in a computer system. Specifically, apparatus 500 can comprise units 502-516, which perform functions or operations similar to logic blocks 622-632 of HVM system 420 of FIG. 4, including: a virtualization unit 502; a booting unit 504; a transaction unit 506; a recovery unit 508, an analysis unit 510; a logging unit 512; a key unit 514; and a communication unit 516.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a system for running a virtual machine (VM) on a host device. During operation, the system can execute, within the VM, a first operating system (OS) running a client application and a second OS running a network protocol stack. The virtual machine can execute on a VMM running on the host device. The first OS can receive a transaction command from the client application. The transaction command can be associated with a remote memory access. The first OS can then convert the transaction command to one or more network packets and provide a description of the one or more network packets to the second OS via a shared guest physical memory of the VM. The host device can then send the one or more network packets to a corresponding destination based on the network protocol stack.

In a variation on this aspect, the remote memory access can be based on Remote Direct Memory Access (RDMA). The transaction command can then include an RDMA transaction.

In a variation on this aspect, a guest physical memory presented to the VM can be partitioned into a plurality of segments, which can include a first memory segment used by the first OS, a second memory segment used by the second OS, and the shared guest physical memory accessible by the first OS and the second OS.

In a variation on this aspect, the VM can provide a plurality of virtual processing units. The first OS can execute on a first subset of the plurality of virtual processing units, and the second OS can execute on a second subset of the plurality of virtual processing units.

In a further variation, the first OS can provide the one or more network packets by issuing an inter-processor interrupt and obtaining the one or more network packets via the shared guest physical memory based on the interrupt.

In a further variation, the first OS can enqueue the description of the one or more network packets in a queue in the shared guest physical memory. The second OS can then dequeue the description from the queue.

In a variation on this aspect, the first OS can run a virtual network interface controller (NIC) operable based on the remote memory access. The virtual NIC can then receive the transaction command from the client application by emulating the remote memory access.

In a further variation, the virtual NIC can determine an address of the corresponding destination based on the transaction command. The virtual NIC can then generate the one or more network packets by incorporating the address.

In a variation on this aspect, the second OS can provide, using a NIC driver running on the second OS, the one or more network packets from the network protocol stack to a physical NIC of the host device. The physical NIC can then transmit the one or more network packets.

In a variation on this aspect, the corresponding destination can include a virtual NIC operable based on the remote memory access.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method comprising:
executing, within a virtual machine (VM) operating on a host device, a first operating system (OS) running a client application and a second OS running a network protocol stack;
receiving, by the first OS, a transaction command from the client application, wherein the transaction command is associated with a remote memory access;
converting, by the first OS, the transaction command to one or more network packets;
providing, by the first OS, a description of the one or more network packets to the second OS via a shared guest physical memory of the VM; and
sending, by the host device, the one or more network packets to a corresponding destination based on the network protocol stack.

2. The method of claim 1, wherein the remote memory access is based on Remote Direct Memory Access (RDMA), and wherein the transaction command includes an RDMA transaction.

3. The method of claim 1, wherein a guest physical memory presented to the VM is partitioned into a plurality of segments comprising a first memory segment used by the first OS, a second memory segment used by the second OS, and the shared guest physical memory accessible by the first OS and the second OS.

4. The method of claim 1, wherein the VM provides a plurality of virtual processing units, wherein the first OS executes on a first subset of the plurality of virtual processing units, and wherein the second OS executes on a second subset of the plurality of virtual processing units.

5. The method of claim 4, wherein providing, by the first OS, the one or more network packets further comprises:
issuing, by the first OS, an inter-processor interrupt; and
obtaining, by the second OS, the one or more network packets via the shared guest physical memory based on the interrupt.

6. The method of claim 5, further comprising:
enqueueing, by the first OS, the description of the one or more network packets in a queue in the shared guest physical memory; and
dequeuing, by the second OS, the description from the queue.

7. The method of claim 1, further comprising:
running, by the first OS, a virtual network interface controller (NIC) operable based on the remote memory access; and
receiving, by the virtual NIC, the transaction command from the client application by emulating the remote memory access.

8. The method of claim 7, further comprising:
determining, by the virtual NIC, an address of the corresponding destination based on the transaction command; and
generating, by the virtual NIC, the one or more network packets by incorporating the address.

9. The method of claim 1, further comprising providing, using a NIC driver running on the second OS, the one or more network packets from the network protocol stack to a physical NIC of the host device, wherein the physical NIC transmits the one or more network packets.

10. The method of claim 1, wherein the corresponding destination includes a virtual NIC operable based on the remote memory access.

11. A non-transitory computer-readable storage medium storing instructions that when executed by a processor of a host device cause the processor to perform a method, the method comprising:
operating a virtual machine (VM) on a virtual machine manager (VMM) running on the host device;
executing, within the VM, a first operating system (OS) running a client application and a second OS running a network protocol stack;
receiving, by the first OS, a transaction command from the client application, wherein the transaction command is associated with a remote memory access;
converting, by the first OS, the transaction command to one or more network packets;
providing, by the first OS, a description of the one or more network packets to the second OS via a shared guest physical memory of the VM; and
sending, by the host device, the one or more network packets to a corresponding destination based on the network protocol stack.

12. The non-transitory computer-readable storage medium of claim 11, wherein the remote memory access is based on Remote Direct Memory Access (RDMA), and wherein the transaction command includes an RDMA transaction.

13. The non-transitory computer-readable storage medium of claim 11, wherein a guest physical memory presented to the VM is partitioned into a plurality of segments comprising a first memory segment used by the first OS, a second memory segment used by the second OS, and the shared guest physical memory accessible by the first OS and the second OS.

14. The non-transitory computer-readable storage medium of claim 11, wherein the VM provides a plurality of virtual processing units, wherein the first OS executes on a first subset of the plurality of virtual processing units, and wherein the second OS executes on a second subset of the plurality of virtual processing units.

15. The non-transitory computer-readable storage medium of claim 14, wherein providing, by the first OS, the one or more network packets further comprises:
issuing, by the first OS, an inter-processor interrupt; and
obtaining, by the second OS, the one or more network packets via the shared guest physical memory based on the interrupt.

16. The non-transitory computer-readable storage medium of claim 15, wherein the method further comprises:
enqueueing, by the first OS, the description of the one or more network packets in a queue in the shared guest physical memory; and
dequeuing, by the second OS, the description from the queue.

17. The non-transitory computer-readable storage medium of claim 11, wherein the method further comprises:
running, by the first OS, a virtual network interface controller (NIC) operable based on the remote memory access; and
receiving, by the virtual NIC, the transaction command from the client application by emulating the remote memory access.

18. The non-transitory computer-readable storage medium of claim 17, wherein the method further comprises:
determining, by the virtual NIC, an address of the corresponding destination based on the transaction command; and
generating, by the virtual NIC, the one or more network packets by incorporating the address.

19. The non-transitory computer-readable storage medium of claim 11, further wherein the method further comprises providing, using a NIC driver running on the second OS, the one or more network packets from the network protocol stack to a physical NIC of the host device, wherein the physical NIC transmits the one or more network packets.

20. A computer system, comprising:
a processor;
a memory device;
a set of ports; and
a network interface controller (NIC);
control circuitry comprising:
a virtualization logic block is to run a virtual machine (VM) on the computer system;
an operating system (OS) logic block is to execute, within the VM, a first OS running a client application and a second OS running a network protocol stack; and
a transaction logic block is to:
receive, at the first OS, a transaction command from the client application, wherein the transaction command is associated with a remote memory access;
convert, at the first OS, the transaction command to one or more network packets; and
provide, from the first OS, a description of the one or more network packets to the second OS via a shared guest physical memory of the VM; and
wherein the NIC is to send the one or more network packets to a corresponding destination based on the network protocol stack.
